(19) United States
(12) Patent Application Publication
(10) Pub. No.: US 2004/0211062 A1
(43) Pub. Date: Oct. 28, 2004

(54) Method for producing a gasket

(76) Inventor: Brian Lang, Roanoke, VA (US)

Correspondence Address: Daniel H. Shulman, Mayer, Brown, Rowe & Maw, P.O. Box 2828, Chicago, IL, 60690-2828, US

(21) Appl. No.: 10/424,360

(22) Filed: Apr. 28, 2003

(51) Int. Cl. B23P 17/00

(52) U.S. Cl. 29/888

(57) ABSTRACT

A method for producing a gasket insert comprising: providing a strip of insert material having a predetermined thickness; providing a pair of rigid parallel surfaces spaced apart by a distance approximately equal to, but greater than, the thickness of the insert material; placing the insert material between the surfaces; and bending the insert material to a desired shape. Also disclosed is a method for producing a gasket comprising: providing a strip of insert material having a predetermined thickness; providing a pair of rigid parallel surfaces spaced apart by a distance approximately equal to, but greater than, thickness of the insert material; placing the insert material between the surfaces; bending the insert material to a desired shape; and molding an elastomeric material to the insert.

### BACKGROUND OF THE INVENTION

1. Field of the Invention

The present invention relates to a method for producing a gasket. In the preferred embodiment, the present invention is directed to an oil pan gasket wherein an elastomer is injection molded to an oil pan gasket insert which is produced using a novel forming process.

2. Description of Related Art

A variety of methods and systems products are known for providing an oil pan gasket. Such oil pan gaskets are typically used in motor vehicles in connection with a transmission or internal combustion engine oil reservoir. Such gaskets may also be used in non-oil pan applications on motor vehicles in connection with internal combustion engine valve covers or differential covers. Typically, the gasket is shaped to follow the approximate perimeter of a pan or cover, which typically has a flat flange with multiple bolt holes for bolts to compress the gasket between the flange and a larger body, such as an engine block, a transmission case, an engine cylinder head or a differential housing. Typically, the gasket comprises at least two materials, with a relatively soft and deformable elastomeric material molded on the surface of the gasket and a relatively rigid material, such as steel, aluminum or thermoplastic, comprising the insert of the gasket. The use of the rigid insert provides structure for the gasket, which can improve the general handling, the installation, the alignment and the general durability of the multiple-material gasket when compared to a gasket comprising only an elastomeric material. Typically, the gasket has multiple through holes positioned at the same locations as through holes in the pan or cover and at the same locations as threaded holes in the aforementioned larger body. Typically, a seal is achieved between the pan or cover and the larger body by deforming the elastomeric material via tightening of bolts that are installed through the pan or cover, installed through the gasket and threaded into the larger body to retain the pan or cover. The insert may be stamped in one or more components from a sheet of metal which is typically at least as wide and as long as the insert. The portion of the sheet that does not become the insert typically comprises more metal than the insert itself, which results in substantial waste of metal. This waste can be reduced by nesting or partial nesting of multiple components with each other but this reduction still involves a substantial amount of wasted metal. Additionally, stamping such an insert typically requires a relatively expensive piece of equipment known as a stamping press to develop the force required to shear the metal along the substantial perimeter of each insert component to separate the insert component from the sheet.

A need exists in the art, therefore, for a gasket insert that can be inexpensively produced using less metal and a forming process with lower force requirements but still provides the necessary rigidity for the gasket.

### SUMMARY OF THE INVENTION

The purpose and advantages of embodiments of the present invention will be set forth in and apparent from the description that follows, as well as will be learned by practice of the invention. Additional advantages of the invention and its several embodiments will be realized and attained by the methods and systems particularly pointed out in the written description and claims hereof, as well as from the appended drawings.

The invention is directed to the formation of a gasket comprising, preferably, an insert having a top side, a bottom side parallel to the top side, an outer periphery and an inner periphery; an elastomer molded over the top side and the bottom side; and wherein the elastomer comprises a deformable sealing protrusion from the top and bottom sides. In some embodiments, the elastomer may be molded around either the inner periphery, the outer periphery, or both. In some embodiments, the elastomer may comprise a deformable sealing protrusion or protrusions from the inner periphery, the outer periphery, or both. In some embodiments, the gasket may have through holes for bolts. In other embodiments, the bolts may be positioned outside of the gasket's outer periphery or inside of the inner periphery, eliminating the need for through holes within the gasket. In a preferred embodiment, the gasket has a relatively rigid insert, has through holes for bolts and is placed on a flat surface of a larger body in a position such that the gasket's through holes are aligned with the larger body's threaded holes, and a pan or cover with through holes in respective positions is installed over the gasket with bolts extending through the pan or cover, extending through the gasket and threaded into the larger body to compress the gasket to create an effective seal between the larger body and the pan or cover.

The advances of the present invention are seen in certain embodiments that permit the waste of less metal to form the insert than had been typical of prior art. For example, using prior art to produce a stamped insert for the gasket for a pan with a relatively rectangular perimeter measuring twelve inches by eighteen inches (total perimeter 60 inches) requires a sheet (which may be part of a continuous coil) of metal measuring at least twelve inches by at least eighteen inches, with a total area of at least 216 square inches. Such a pan would typically have radiused corners, instead of sharp corners, and the difference in area between a perfect rectangle with sharp corners and a relatively rectangular shape caused by these radii are small enough to be considered negligible for purposes of this example of prior art. The gasket may have a width of 0.5 inches, such that its net area is only 0.5″×60″=30 square inches. The seventeen-inches-by-eleven-inches remainder of metal from the inner periphery of the gasket may be waste. Producing the insert from two separate L-shaped pieces that are partially nested during the stamping process and joined after stamping, or producing other products from the seventeen-inches-by-eleven-inches remainder of metal, may reduce the amount of waste, but it will not reduce it to the level of the present invention. Furthermore, this prior art example method would require a substantial amount of shearing force from a stamping press to separate the component or components from the base sheet of metal.

The present invention permits the use of a strip of metal to produce the insert by forming the strip between two parallel, rigid surfaces. The surfaces are a fixed distance apart, with that distance being approximately equal to, but just larger than, the thickness of the strip of metal. The strip is placed between the rigid surfaces and bent from the side. The surfaces prevent the strip from buckling as it bends. In preferred embodiments, a wrap-around piece, such as a post, is placed along the inner edge of the strip. The strip is bent around the wrap-around piece to produce the radiused, i.e., curved, corners or other possible non-linear features of the insert. The present invention may have waste in the from of relatively small, circular pieces of scrap resulting from punching through holes in the insert, but this scrap is relatively minor when compared to the waste of the prior art method. At each of the bolt holes, the gasket may or may note have relatively rigid features known in the art as compression limiters, whose function is to prevent tightening of the bolts from excessively deforming and therefore damaging the elastomeric material. These compression limiters may comprise separate components that are installed in the insert or they may be formed of the same material as the insert.

In brief, an embodiment of the invention is a method for producing a gasket insert comprising: providing a strip of insert material having a predetermined thickness; providing a pair of rigid parallel surfaces spaced apart by a distance approximately equal to, but greater than, the thickness of the insert material; placing the insert material between the surfaces; and bending the insert material to a desired shape. A further embodiment is disclosed wherein the step of bending the insert material comprises: providing a wrap-around piece along a side of the insert material; and pushing or pulling the insert material around the wrap-around piece to bend the insert material around the wrap-around piece. The wrap-around piece may be circular or elliptical, or any shape needed to make the desired bend. The opposite ends of the insert material may be joined to form a contiguous insert. In other embodiments, holes or compression limiters may additionally be provided. The insert material may be of any suitable material including metal, such as steel or aluminum, or plastic.

In yet further embodiments of the invention, a gasket may be produced by molding an elastomeric material around the insert.

It is to be understood that both the foregoing general description and the following detailed description are exemplary and are intended to provide further explanation of the invention claimed.

The accompanying drawings, which are incorporated in and constitute part of this specification, are included to illustrate and to provide a further understanding of the methods and embodiments of the invention. Together with the description, the drawings serve to explain the principles of the invention.

### BRIEF DESCRIPTION OF THE DRAWINGS

FIG. 1 is a top view of a gasket insert.

FIG. 2 is an enlarged cross-sectional view of a portion of a gasket.

FIG. 3 is an enlarged cross-sectional view of a portion of another gasket.

FIG. 4 is an elevated view of a stage of the method according to an embodiment of the present invention.

FIG. 5 is a plan view of the components used in accordance with the present method.

### DETAILED DESCRIPTION OF THE PREFERRED EMBODIMENT

Reference will now be made in detail to the present preferred embodiments of the invention, an example of which is illustrated in the accompanying drawing. The method and corresponding steps of the invention will be described in conjunction with the detailed description.

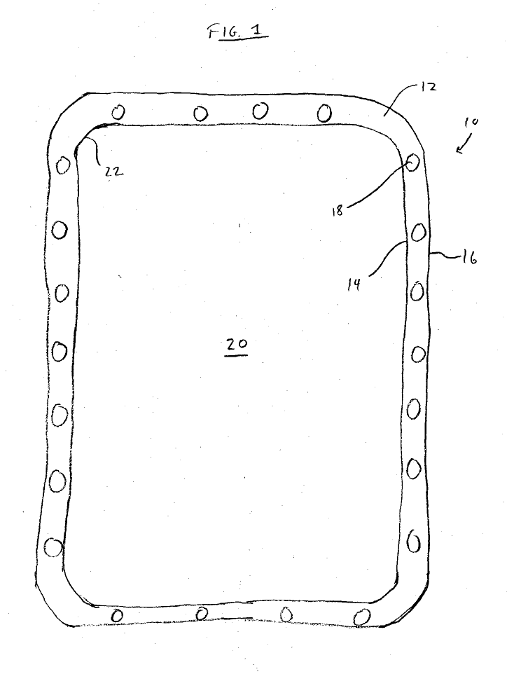

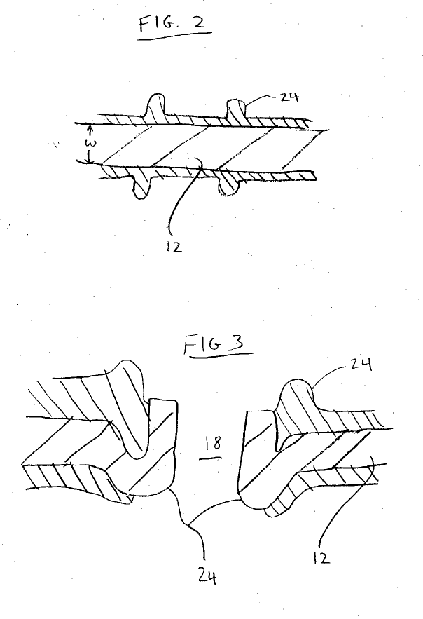

For purpose of explanation and illustration, and not limitation, an exemplary embodiment of a gasket insert in accordance with the invention is shown in FIG. 1 and FIG. 2 and is designated generally by reference character 10. The gasket is designed for use in a variety of motor vehicle systems, including without limitation, engine valve covers, engine oil pans, transmission oil pans, transfer case oil pans, and differential covers. According to those systems, a thin-walled pan or cover encapsulates a fluid within a larger body, such as an engine block or a transmission case. The junction between the pan or cover must be sealed to prevent leakage of the fluid and possible intrusion of foreign material. Installation of a rubber gasket at this junction to accomplish the required sealing is made easier if the gasket includes a relatively rigid insert. This insert may or may not include compression limiting features to protect the rubber from overcompression when the bolts are tightened.

According to the present embodiment, the gasket insert is generally open in its middle when viewed from above, with a relatively thin sealing feature(s) that follows the general path of the sealing surface of the pan that will contain fluid. The gasket insert comprises an insert material 12 having a top side, a bottom side, an outer periphery 16 and a generally parallel inner periphery 14 defining a central opening 20. The insert may alternately be made of plastic or other material suitable to the particular environment. The insert Should be thin and strong enough to support the entire gasket when held by only one end, although it may be relatively flexible. When the gasket is placed against a sealing surface for installation, its bolt holes 18 are positioned by the insert to be aligned with the bolt holes in the sealing surface.

The insert may be constructed alternately with no through holes for bolts, as some applications may have bolt holes that are either inside of or outside of the gasket's area, and other applications may rely upon means other than bolts to clamp the two sealing surfaces together toward the gasket.

A gasket is made by molding an elastomer around the insert. In FIG. 2, an elastomer 24 is molded with or without adhesive bonding to the insert 12. The elastomer 24 may be molded on any or all of the following surfaces: the top side, the bottom side, the outer periphery or the inner periphery. The elastomer 24 may or may not completely encapsulate the insert as shown in FIG. 2. The elastomer 24 typically comprises a material such as synthetic fluorocarbon elastomer, ethylene acrylic, other synthetic elastomers, natural rubber or blends. The insert material 12 has a thickness t. In FIG. 3, compression limiters 24 are provided in the gasket. Typically, although not necessarily, the compression limiters 24 are provided prior to molding the elastomer. Similarly, the bolt holes 18 are typically, although not necessarily, stamped prior to molding the elastomer. In the embodiment depicted in FIG. 3, the compression limiters 24 comprise crimped portions of the insert 12.

The features and advantages of preferred embodiments of the present invention are achieved through the use of the manufacturing method, embodiments of which are described herein. The methods of the present invention achieve a molded gasket wherein an elastomer is molded to a gasket insert that is formed from a relatively narrow strip of material, permitting decreased material usage and the use of potentially-less-expensive equipment, and hence a less-expensive gasket. The insert is then placed into a rubber mold which molds the elastomer to the insert. The insert may or may not have been coated with adhesive for elastomer bonding prior to the molding of the elastomer. The insert may or may not have through holes for mechanical locking of the elastomer to the insert. The insert may or may not have compression-limiting features to prevent overcompression of the elastomer. Typically, the elastomer is added to the mold via injection, transfer or compression molding.

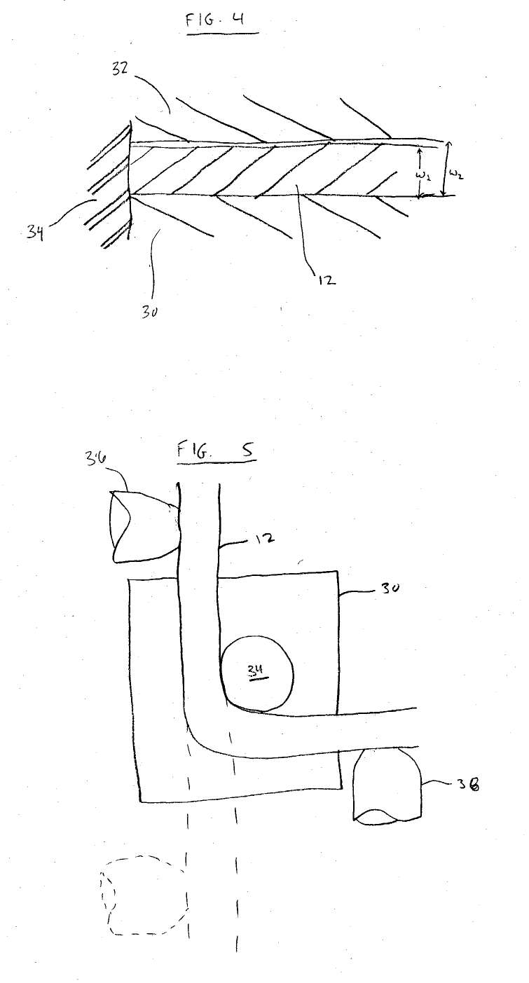

An embodiment of the method according to the present invention is as follows. A strip of insert material is provided. In typical applications, the strip is approximately 0.5 inches wide and approximately 0.04 inches thick, and comprises a metal, such as steel or aluminum, or a plastic. Two parallel rigid surfaces are further provided. The surfaces are generally steel and are at least as large as the area of the bend. The surfaces are a fixed distance apart, with the distance being approximately equal to, but greater than, the thickness of the strip of insert material. For example, if the strip is 0.04 inches thick, the surfaces may be placed 0.044 inches apart in accordance with the present invention. The 0.004 inches of buckling is considered insignificant and is far less that what would occur without the rigid surfaces. According to the preferred embodiment, the surfaces would need to have sufficient clearance for variations in the thickness of the material and well as providing room for the strip to move between the plates. In preferred embodiments, this would require the surfaces to be set approximately 0.004 inches wider than the thickness of the strip. Referring to FIG. 4, a strip 12 with thickness t₁ is placed between two surfaces 30, 32 a distance t₂ apart, wherein t₂ is approximately equal to, but greater than, t₁. A wrap-around piece 34 is also provided.

Once the insert material 12 is placed between the surfaces 30, 32, it can be bent to a desired shape. The surfaces 30, 32 will exert pressure on the insert material 12 if and to the extent it starts to buckle from the bending. The surfaces 30, 32 thereby prevent buckling at the bent areas. In application, the strip 12 may be bent at corners, or in any area where the contour of the gasket is desired to be nonlinear. FIG. 5 depicts a bending mechanism. In FIG. 5, the top surface 32 is not shown. In operation, the strip 12 is place between the surfaces 30, 32 with a wrap-around piece 34, such as a circular pin placed along one side of the strip of insert material 12. A first retaining piece 36 is positioned along the side of the strip material 12 opposite the wrap-around piece 34. The retaining piece 36 will provide a counterforce to hold the end of the strip material 12 during the bending. Alternatively, clamps or other retaining means may be employed. A pushing block 38 is provided on the side of the strip material 12 opposite the wrap-around piece 34. The dashed lines depict the positions of the components prior to bending. As the pushing block 38 pushes the end of the strip 12, it bends around the wrap-around piece 34. The degree of bend is controlled by how far the pushing block 38 pushes the strip 12. The radius of the bend is determined by the shape of the wrap-around piece 34. In practice, the pushing block 38 could be operated by hand, by a motor, by hydraulics, or by any other means of movement. Alternatively, the strip 12 may be pulled, for example with clamps, around the wrap-around piece.

The gasket insert, when formed can be stamped to provide bolt holes or compression limiters. In addition, a final step of molding an elastomer to the insert, such as by injection, compression or transfer molding, can complete the production of a gasket.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

What is claimed is:

1. A method for producing a gasket insert comprising:
providing a strip of insert material having a predetermined thickness;
providing a pair of rigid parallel surfaces spaced apart by a distance approximately equal to, but greater than, the thickness of the insert material;
placing the insert material between the surfaces; and
bending the insert material to a desired shape.

2. The method of claim 1 wherein the step of bending the insert further comprises:
providing a wrap-around piece along a side of the insert material;
pushing or pulling the insert material around the wrap-around piece to bend the insert around the wrap-around piece.

3. The method of claim 2 wherein the wrap-around piece is circular.

4. The method of claim 2 wherein the wrap-around piece is elliptical.

5. The method of claim 1 further comprising joining opposite ends of the insert material to form a contiguous insert.

6. The method of claim 1 further comprising stamping bolt holes in the insert material.

7. The method of claim 1 further comprising providing compression limiters in the insert material.

8. The method of claim 1 wherein the insert material is metal.

9. The method of claim 8 wherein the insert material is steel.

10. The method of claim 8 wherein the insert material is aluminum.

11. The method of claim 1 wherein the insert material is plastic.

12. A method for producing a gasket comprising:
providing a strip of insert material having a predetermined thickness;
providing a pair of rigid parallel surfaces spaced apart by a distance approximately equal to, but greater than, the thickness of the insert material;
placing the insert material between the surfaces;
bending the insert material to a desired shape; and
molding an elastomeric material to the insert.

13. The method of claim 12 wherein the step of bending the insert further comprises:
providing a wrap-around piece along a side of the insert material;
pushing or pulling the insert material around the wrap-around piece to bend the insert around the wrap-around piece.

14. The method of claim 13 wherein the wrap-around piece is circular.

15. The method of claim 13 wherein the wrap-around piece is elliptical.

16. The method of claim 12 further comprising joining opposite ends of the insert material to form a contiguous insert.

17. The method of claim 12 further comprising stamping bolt holes in the insert material.

18. The method of claim 12 further comprising providing compression limiters in the insert material.

19. The method of claim 12 wherein the insert material is metal.

20. The method of claim 19 wherein the insert material is steel.

21. The method of claim 19 wherein the insert material is aluminum.

22. The method of claim 12 wherein the insert material is plastic.
